(19) United States
(12) Patent Application Publication
(10) Pub. No.: US 2012/0023549 A1
(43) Pub. Date: Jan. 26, 2012

(54) CAPTCHA AND reCAPTCHA WITH SINOGRAPHS

(75) Inventors: Ling-Jyh Chen, Taipei (TW); Der-Ming Juang, Keelung City (TW); Wen-Yuan Zhu, Taoyuan City (TW); Hsiao-Hsuan Yu, Kaohsiung City (TW); Fu-Wei Chen, Zhonghe City (TW)

(73) Assignee: Academia Sinica, Taipei (TW)

(21) Appl. No.: 13/187,652

(22) Filed: Jul. 21, 2011

Related U.S. Application Data
(60) Provisional application No. 61/367,119, filed on Jul. 23, 2010.

(51) Int. Cl. G06F 21/00

(52) U.S. Cl. 726/2

(57) ABSTRACT

A method for inviting a challenged entity to provide input concerning a sinograph includes displaying, to the challenged entity, a first region having an image of a challenge sinograph; displaying at least a first event-sensitive region, the first event-sensitive region having an image of a real root of the challenge sinograph; and displaying at least a second event-sensitive region. The second event sensitive region has an image of a faux root of the challenge sinograph.

### RELATED APPLICATIONS

This application claims the benefit of the Jul. 23, 2010 priority date of U.S. Provisional Application 61/367,119, the contents of which are herein incorporated by reference.

### FIELD OF DISCLOSURE

This disclosure relates to Turing tests, and in particular to automated public Turing tests, such as CAPTCHA and reCAPTCHA.

### BACKGROUND

Both CAPTCHA (“Completely Automated Public Turing test to tell Computers and Humans Apart”) and reCAPTCHA are known ways of harnessing a human being's continued superiority over machines in certain kinds of pattern recognition.

In CAPTCHA, the goal is to distinguish between a human being and a machine-implemented human imposter, such as a bot, on the basis of their differential abilities at pattern recognition.

An entity to be challenged, hereafter referred to as the “challenged entity,” is presented with a warped or distorted version of a set of letters and characters. The challenged entity then types in those letters and characters on the keyboard. To the extent what the challenged entity's input matches what was displayed, the challenged entity is presumed human. This ability to distinguish between humans and bots is particularly useful for web sites that attempt to exclude bots and other machine-implemented human imposters.

CAPTCHA has thus been widely implemented by online services for preventing bots from accessing online services, including electronic commerce services, e-mail services, blogs, forums, and social networks.

In reCAPTCHA, the goal is to exploit the human being's superiority in pattern recognition to assist in optical character recognition. Typically, a challenged entity is presented with a known word and an unknown word and asked to type both words. To the extent the challenged entity types the known word correctly, one can assume that it is human and not a bot. Consequently, the probability of the challenged entity having typed the unknown word correctly is relatively high.

A difficulty with known implementations of CAPTCHA and reCAPTCHA is their reliance on characters from an alphabet. However, not all written languages use alphabets. Some written languages rely on logographs. Those who are literate only on such languages face difficulty when using existing CAPTCHA and reCAPTCHA implementations. Examples of languages that rely on logographs for written communication are Chinese, which relies almost exclusively on sinographs, and Korean and Japanese, which rely in part on Hanja and Kanji characters respectively.

Existing Chinese CAPTCHA implementations assume knowledge of sinograph keyboard entry and/or literacy in Chinese.

### SUMMARY

The invention described herein enables Chinese CAPTCHA to be used even by those who are not literate in Chinese. Furthermore, because the invention described herein dispenses with the need for a keyboard, it enables Chinese CAPTCHA to be used by those who do not know how to enter Chinese characters on a keyboard.

The invention is based in part on the recognition that sinographs can be decomposed into elementary units, referred to herein as “roots”, which are difficult for a bot to recognize. A challenger can then challenge a challenged entity by displaying both a warped sinograph and a set of roots, some of which are correct, and some of which are incorrect. The displayed roots can then be clicked upon or otherwise activated. By actuating the correct displayed roots, the challenged entity can communicate to the challenger that he is in fact human.

An invention along the lines of the foregoing offers numerous advantages over the state of the art.

First, because the input is click-based, no keyboard is needed. This is especially useful for emerging devices that have dispensed with keyboards altogether, such as touch panels and certain kinds of smart phones.

Second, the invention exploits sinographic structure in its design. In doing so, it extends the benefits of CAPTCHA to Chinese speakers, who no longer need to surmount language barriers to use a Chinese CAPTCHA or reCAPTCHA system.

Third, the invention facilitates the extension of OCR techniques to the recognition of sinographs and similar logographs.

In one aspect, the invention features a method for inviting a challenged entity to provide input concerning a sinograph. Such a method includes displaying, to the challenged entity, a first region having an image of a challenge sinograph; displaying at least a first event-sensitive region, the first event-sensitive region having an image of a real root of the challenge sinograph; and displaying at least a second event-sensitive region. The second event sensitive region has an image of a faux root of the challenge sinograph.

Some practices also include classifying the challenged entity on the basis of an interaction between the challenged entity and the event-sensitive regions. Among these practices are those that further include determining that the challenged entity has interacted with the second event-sensitive region, and classifying the challenged entity as non-human, as well as those that include identifying the challenged entity as a human based at least in part on an interaction with the first event-sensitive region.

In some practices, displaying the second event-sensitive region includes selecting a faux root based on its stroke count. In particular, one way to carry out such a selection is to choose a faux root having a stroke count that is equal to a stroke count of the real root displayed in the first event-sensitive region.

Other practices include those in which displaying the second event-sensitive region includes selecting a faux root that resembles the real root.

In some practices, there are limits on the sinographs that can be used as challenge sinographs. In such cases, the method can also includes extracting, from a set of sinographs, a subset of sinographs having properties suitable for use as challenge sinographs. This might include, in some practices, extracting a sinograph having a set of roots that are not found in other sinographs in the set.

Another way to select sinographs in an alternative practice is to select, from a set of sinographs, a sinograph made from a set of roots, each root being different from all other roots in the set.

Yet another practice includes displaying, to the challenged entity, a second region, the second region having an image of an unrecognized sinograph; displaying, to the challenged entity, candidate sinographs corresponding to the unrecognized sinograph; and soliciting, from the challenged entity, information identifying which of the candidate sinographs the challenged entity regards as the same as the unrecognized sinograph.

Among the foregoing practices are those that also include assessing a confidence in the challenged entity's identification of the candidate sinograph based at least in part on the success with which the challenged entity identified the real roots of the challenge sinograph, and those in which the unrecognized sinograph is a sinograph that OCR was unable to recognize.

In another aspect, the invention features an apparatus for soliciting input concerning a displayed sinograph. Such an apparatus includes a challenge selector for selecting a sinograph for use as a challenge sinograph; a rooter for obtaining at least one real root of the challenge sinograph and for obtaining at least one faux root; and a display module for causing a display to display an image of the challenge sinograph in a first display region, and images of the at least one faux root and the at least one real root in corresponding second and third display regions, the second and third display regions being event-sensitive regions.

Embodiments of the apparatus include those in which the challenge selector is configured to select a sinograph on the basis of roots of the sinograph.

Also among the embodiments of the apparatus are those in which the rooter is configured to select the faux root on the basis of a resemblance between the faux root and a real root, and those in which the rooter is configured to select the faux root such that the faux root and the real root have the same number of strokes.

In yet another aspect, the invention includes a tangible and non-transitory computer readable medium having encoded thereon software for inviting a challenged entity to provide input concerning a sinograph, the software comprising instructions for executing any or all of the above methods.

In yet another aspect, the invention features an apparatus for assessing an extent to which constituent elements of a sinograph are correctly identified. Such an apparatus includes means for displaying, to a challenged entity, a sinograph, and constituent elements thereof, the constituent elements being displayed on event-sensitive regions; means for receiving, from the challenged entity, information representative of interaction with the event-sensitive regions; and means for assessing, based on the information, whether the challenged entity correctly identified the sinograph.

Some embodiments further include means for displaying to the challenged entity, an unrecognized sinograph for which human assistance in recognition is sought. Other embodiments include those that also have means for generating elements that mimic the constituent elements in appearance.

In yet another practice, the invention features a method for assessing human interpretation of an image of one or more characters. Such a method includes presenting, to a user, an image of the one or more characters and images of a plurality of other characters, at least some of which are related to the one or more characters; accepting input from the user identifying a subset of the plurality of other characters; and assessing the human interpretation of the image based on the accepted input.

Among the foregoing practices are those that also include determining a set of root characters of the one of more characters, with at least some of the plurality of other characters being related to a corresponding member of the set of root characters.

In some practices, the one or more characters include Asian language characters. Among these practices are those in which the one or more characters include Chinese script characters.

Other practices include those in which presenting the images of characters to the user includes presenting obscured and/or distorted images of the characters.

Yet other practices include those in which accepting input from the user includes accepting a pointer-based input from the user.

Among the practices of the invention are those in which determining the human interpretation includes determining if the identified subset of the other characters are related to the one or more characters.

Also included in the many variants of the invention are practices in which the steps of presenting and accepting are repeated with many users. In these practices, determining the human interpretation includes combining the identified subsets of the plurality of characters.

Yet other practices also include determining at least some of the other characters based on a computer-based recognition of the one or more characters.

Additional practices of the invention include determining at least some of the other characters based on character features of the one or more characters or roots of said characters. Among these practices are those in which the character features include a number of strokes.

These and other features of the invention will be apparent from the following detailed description and the accompanying figures in which:

### BRIEF DESCRIPTION OF THE FIGURES

FIG. 1 is a block diagram for one implementation of a system for implementing the sinograph CAPTCHA method described herein;

FIG. 2 shows a challenge sinograph decomposed into its roots, and sinographs having structures that would be excluded from use by the challenge filter shown in FIG. 1;

FIG. 3 shows steps in execution of the sinograph CAPTCHA method implemented by the system shown in FIG. 1; and

FIGS. 4-7 summarize steps in a reCAPTCHA method.

### DETAILED DESCRIPTION

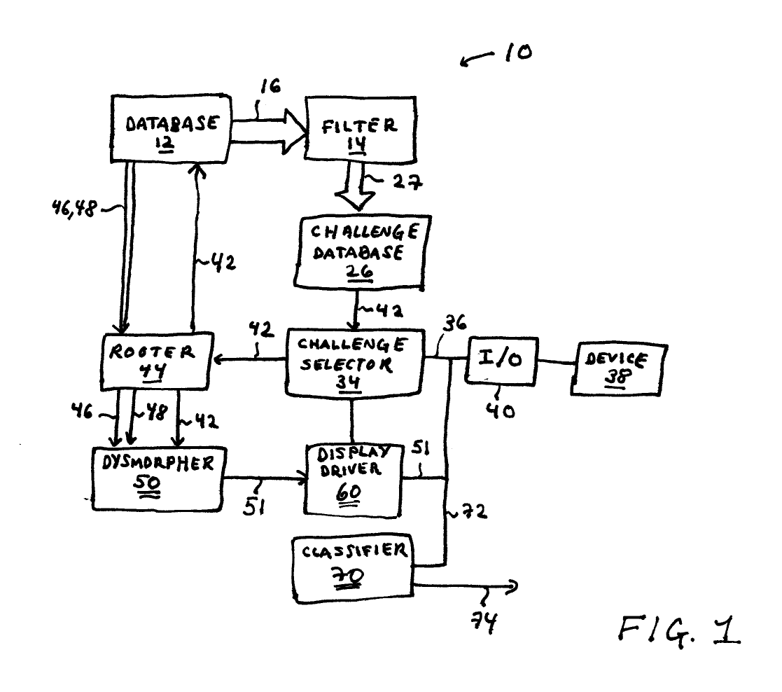

Referring to FIG. 1, a challenger 10 includes a sinograph database 12 from which a challenge filter 14 has extracted sinographs 16 that would be suitable for use in a CAPTCHA challenge. A suitable sinograph database 12 is the Chinese Character Dataset, which was built, and is being maintained by the Institute of Information Science, Academia Sinica. This database 12 includes more than 60,000 sinographs, as well as building components, or roots, of each sinograph.

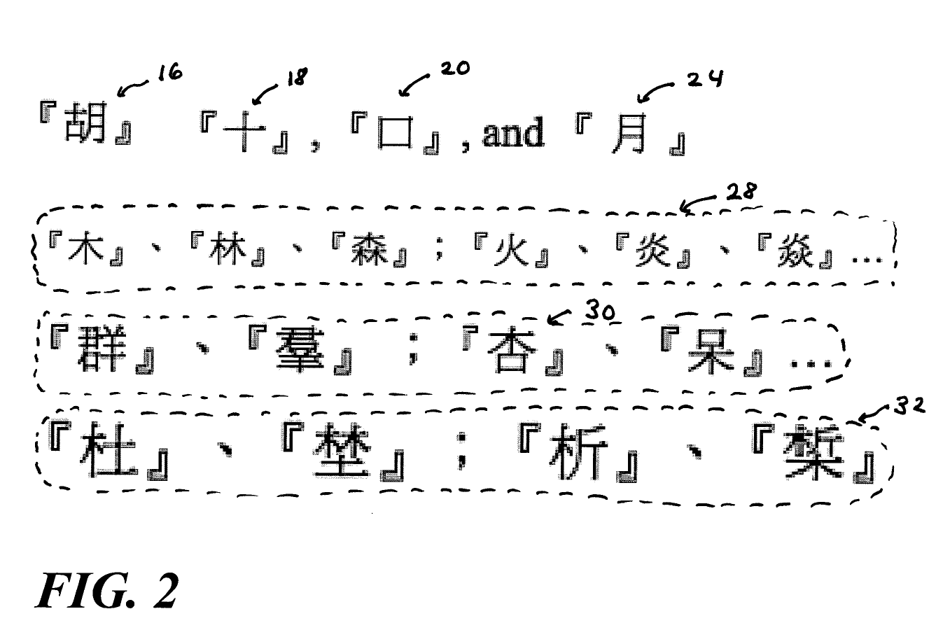

Approximately 85% of sinographs are created from a unique set of roots. FIG. 2 shows an example of a sinograph 16 having first, second, and third roots 18, 20, 24.

Referring back to FIG. 1, the challenge filter 14 creates a challenge database 26 that includes only those sinographs 27 that are created from a unique set of roots. Referring again to FIG. 2, examples of sinographs excluded by the filter would be those 28 that have repeated roots, and those 30 which have the same roots but in different positions within the sinograph 16, and those 32 that have both of the foregoing properties in combination.

A challenge selector 34 receives a challenge request 36 from a device 38 through a device interface 40. In response, the challenge selector 34 selects a sinograph, hereafter referred to as the “challenge sinograph 42” from the challenge database 26. This challenge sinograph 42 is provided to a rooter 44. The rooter 44 then obtains at least a subset of the constituent roots 46 for the challenge sinograph 42. These roots 46 will hereafter be referred to as the “real roots.” In addition, the rooter 34 obtains a plurality of “faux roots” 48.

In some embodiments, the rooter 44 selects the faux roots 48 to resemble the real roots 46 to an extent that makes it difficult for a bot to identify the real roots 46, but not to such a great extent as to make it difficult for a human to identify the real roots 46. A variety of metrics can be used to indicate resemblance between a faux root 48 and a real root 46. A useful one is an extent to which the number of strokes associated with the faux root 48 and real root 46 differ.

The total number of roots 46, 48 depends on the number of roots to be displayed to the challenged entity. The higher this number is, the more difficult it will be for a bot to randomly guess the real roots 46. On the other hand, if this number is too high, it can become burdensome for a human to find the real roots.

In a typical implementation, it is not necessary to display all the real roots 46. In many cases, it is enough to display a subset of the real roots 46.

The challenge sinograph 42, its real roots 46, and faux roots 48, are provided to a dysmorpher unit 50 that applies a dysmorphing transformation to selected inputs thereof. The output 51 of the dysmorphing transformation is a warped or otherwise distorted image corresponding to an input image. The dysmorpher unit 50 can apply different degrees of dysmorphication to different inputs.

The dysmorpher unit 50 may be configured to distort some inputs and not others. For example, in some practices, only the challenge sinograph 42 is dysmorphed, while its real roots 46 and the faux roots 48 are left in their original form. This approach makes it more difficult for bots to perform image processing for determining the real roots 46, while making it easier for humans to complete the challenge. In other practices, the dysmorpher unit 50 applies different image transformations to the challenge sinograph 42 and the roots 46, 48.

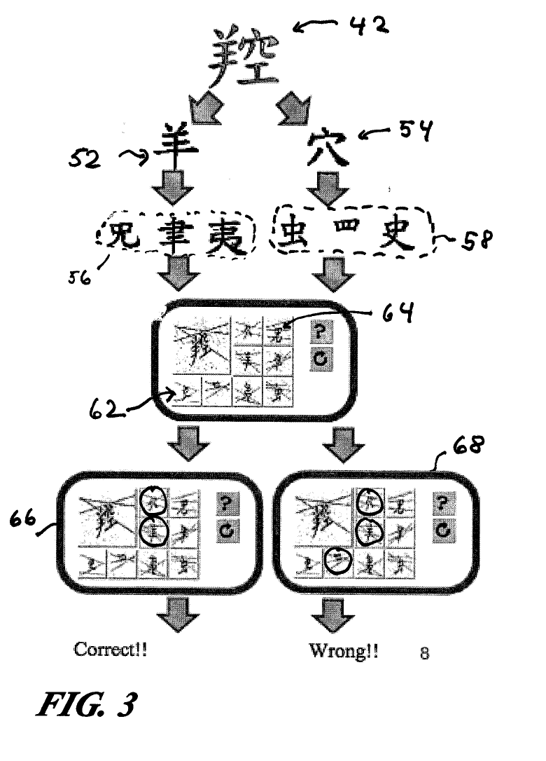

FIG. 3 illustrates the operation of the Chinese CAPTCHA system as described in connection with FIG. 1. As shown in FIG. 3, a challenge sinograph 42 is made up of three roots, two of which 52, 54 are chosen for display to a challenged entity. The first real root 52 is made from six strokes, whereas the second real root 54 is made from five strokes.

The rooter 44 then chooses corresponding faux roots 48. As faux roots for the first real root 52, the rooter 44 selects three roots 56 that, like the first real root 52, are also made from six strokes. As faux roots for the second real root, the rooter 44 selects three roots 58 that, like the second real root 54, are also made from five strokes.

A display driver 60 (see FIG. 1) then creates a CAPTCHA puzzle 62 showing two real roots 52, 54 and two sets 56, 58 of three faux roots, together with the challenge sinograph 42 for display on the device 38. The device 38 can be a personal computer or a handheld device, such as a smart phone, with or without a haptic display, or a tablet computer, or a pad with or without a haptic display.

Each root 56, 58 is in an event-sensitive region 64 of the CAPTCHA puzzle 62. An event-sensitive region 64, as used herein, is one that can send a signal indicative of its selection without having to be selected by a keyboard. For example, an event-sensitive region 64 can be clicked upon using a mouse or similar pointing device. Or an event-sensitive region 64 could be haptically sensitive, and therefore activated simply by touch. Typical event-sensitive regions appear as buttons on a display.

In display 66 in FIG. 3, the challenged entity has interacted with event-sensitive regions 64 displaying the real roots 52, 54. Consequently, the puzzle is solved and the challenged entity has passed the Turing test. In contrast, in display 68, the challenged entity has interacted with an event-sensitive region 64 having a faux root 58. The challenged entity thus fails the Turing test.

A classifier 70 receives information 72 indicative of the interaction between the challenged entity and the event-sensitive regions 64. On the basis of its interaction with the event-sensitive regions 64, the classifier 70 provides an output 74 that classifies the challenged entity as being human or non-human. For example, if the challenged entity has activated too many event-sensitive regions 64 with faux roots 48 displayed thereon the classifier 70 classifies the challenged entity as non-human. On the other hand, if the challenged entity interacts with enough event-sensitive regions 64 having real roots displayed thereon, the classifier 70 assumes, on the basis of this performance, that the challenged entity must be human.

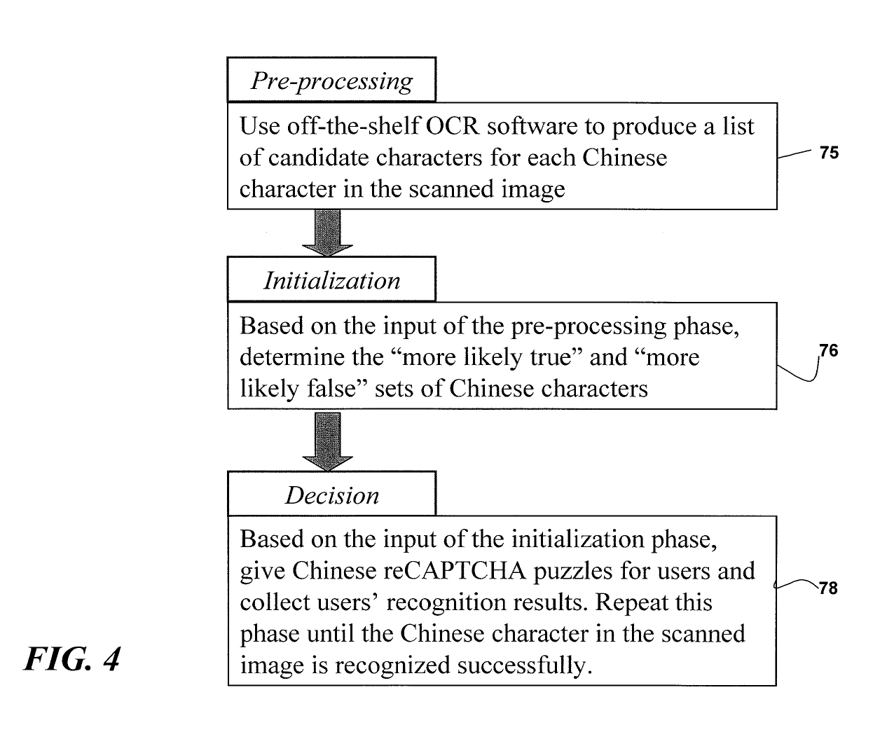

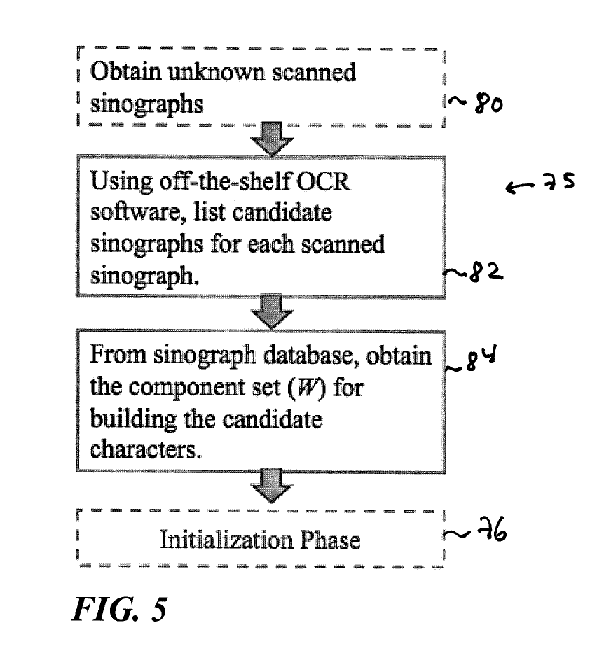

A reCAPTCHA algorithm based on the foregoing principle, as shown in FIG. 4, begins with a scanned image having an unrecognized sinograph for which human assistance in recognition is sought. In a pre-processing phase 75, off-the-shelf OCR software is used to produce a list of candidate sinographs corresponding to the unrecognized sinograph. Then, in an initialization phase 76, the probability that each candidate sinograph is the unrecognized sinograph is calculated. Finally, in a decision phase 78, the challenged entities are provided with reCAPTCHA puzzles using the unknown sinograph as a challenge sinograph 42 and using the candidate sinographs in place of roots. The details of each phase are discussed in connection with FIGS. 5-7.

As shown in FIG. 5, the pre-processing phase 75 begins with obtaining one or more unrecognized sinographs from scanned images (step 80). Known OCR algorithms are then applied to generate a corresponding list of candidate sinographs (step 82). The rooter 44 then retrieves the set of roots (W) for each of the candidate sinographs (step 84).

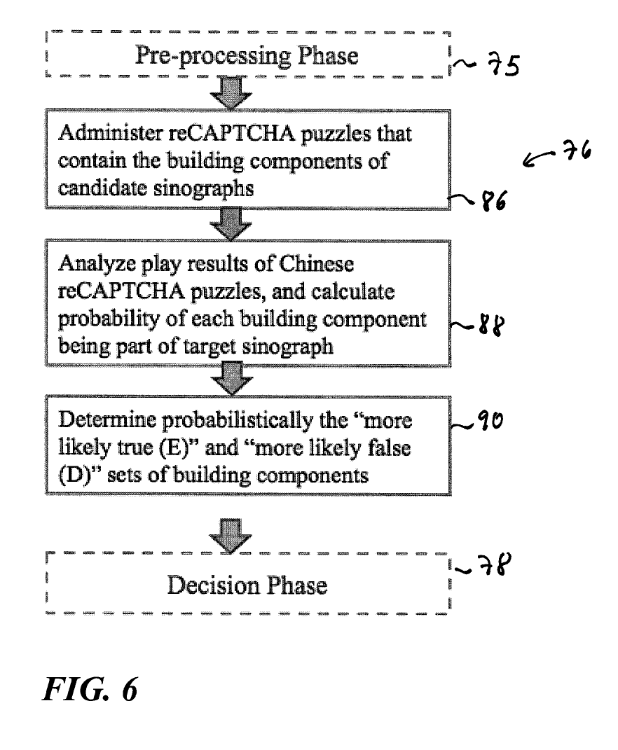

The initialization phase 76, summarized in FIG. 6, begins with administering reCAPTCHA puzzles that contain the unrecognized sinograph and the roots of the candidate sinographs (step 86). Based on results from the reCAPTCHA puzzles, it is possible to estimate the probability that a particular root is indeed part of the unrecognized sinograph (step 88). Based on the foregoing probabilities associated with roots, one can determine a set of components (“E”) that are more likely to correspond to the unrecognized sinograph, and a set of components (“D”) that are less likely to correspond to the unrecognized sinograph (step 90).

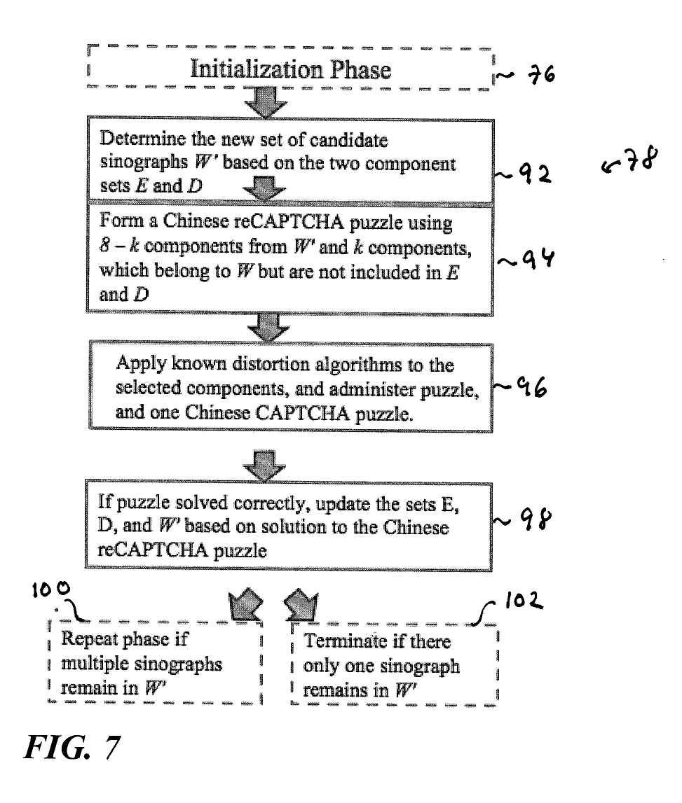

Finally, in the decision phase 78, shown in FIG. 7, a set of candidate sinographs W′ is formed based on the two root sets E and D (step 92). Then, an 8-root reCAPTCHA puzzle (i.e. a puzzle having at least eight event-sensitive regions 64) is formed using 8-k roots that belong to the set of candidate sinographs W′ and k roots that belong to the set W′ but are not part of sets E or D (step 94). The roots are then dysmorphed and presented in a CAPTCHA puzzle together with one known sinograph (step 96). If the CAPTCHA puzzle is solved correctly, sets E, D, and W′ are updated accordingly based on the user's input to the reCAPTCHA puzzle (step 98). This phase is repeated as long as there are multiple sinographs in the set W′ (step 100). It is terminated when only one sinograph remains in the set W′ (step 102).

The foregoing method is thus based in part on the composition of a sinograph. As a result, a challenged entity who is human can apply his observation and/or pattern recognition skills to succeed in the challenge, without having to actually know the meaning of, or the pronunciation of the sinographs. Moreover, because it does not rely on a keyboard, the foregoing method is suitable for modern mobile handheld devices.

A CAPTCHA method as disclosed herein can be used by web applications and mobile applications to distinguish between humans and bots. In this application, a link to the CAPTCHA challenge apparatus can be embedded on a web page or in a mobile application on a handheld. In addition, the method can be applied in interactive learning applications for teaching sinographs.

The apparatus shown in FIG. 1 is a physical and tangible apparatus that consumes electricity. The method described herein is tied to that particular apparatus. The apparatus executes software, which is encoded in a tangible and non-transitory computer-readable medium. To the extent the apparatus is regarded as a general purpose computer, it is transformed into a special purpose machine by the above-mentioned software.

Execution of the software also transforms matter within the machine by causing the motion of charge, thus altering the overall charge distribution within the machine. In the course of doing so, heat is generated. This causes expansion of the materials from which the circuitry is made. Heating also changes the electrical properties of semiconductors within the machine. A change in a material property such as conductivity is clearly a transformation of matter. This is another transformation of matter. Currents flowing within the machine also generate magnetic fields that interact with magnetic fields and thus generate forces.

To the extent the foregoing transformations are deemed to be small, they are nevertheless real. Hence, it cannot be denied that the method described and claimed herein is both tied to the particular machine of FIG. 1 and also carries out transformations of matter in the course of its operation.

Implementations of this approach may be implemented in software, for instance that is stored on a tangible and non-transitory computer readable medium, and which when executed by a computer processor causes a data processing system to perform the steps described above.

In some applications, the image presentation is formed at a server computer and passed to a client computer or device where the user makes the selections of the related characters. The selection is then passed back to the server for further processing. In some applications, some of the steps are performed at the client computer or device, and in some applications, the entire procedure is performed on a single device. In some examples, the presentation is on display of a handheld device, and the selection of the characters is performed by the user with a pointing approach (e.g., mouse, touch-screen, cursor).

Having described the invention, and a preferred embodiment thereof, what we claim as new, and secured by letters patent is:

1. A method for inviting a challenged entity to provide input concerning a sinograph, said method comprising:
displaying, to the challenged entity, a first region having an image of a challenge sinograph;
displaying, to the challenged entity, at least a first event-sensitive region, said first event-sensitive region having an image of a real root of said challenge sinograph; and
displaying, to the challenged entity, at least a second event-sensitive region, said at second event sensitive region having an image of a faux root of said challenge sinograph.

2. The method of claim 1, further comprising classifying said challenged entity on the basis of an interaction between said challenged entity and said event-sensitive regions.

3. The method of claim 2, further comprising determining that said challenged entity has interacted with said second event-sensitive region, and classifying said challenged entity as non-human.

4. The method of claim 2, further comprising identifying said challenged entity as a human based at least in part on an interaction with said first event-sensitive region.

5. The method of claim 1, wherein displaying said second event-sensitive region comprises selecting a faux root having a stroke count that is equal to a stroke count of said real root displayed in said first event-sensitive region.

6. The method of claim 1, wherein displaying said second event-sensitive region comprises selecting a faux root that resembles said real root.

7. The method of claim 1, wherein displaying said first event-sensitive region comprises extracting, from a set of sinographs, a subset of sinographs having properties suitable for use as challenge sinographs.

8. The method of claim 7, wherein extracting a subset of sinographs comprises extracting a sinograph having a set of roots that are not found in other sinographs in said set.

9. The method of claim 1, wherein displaying said first event-sensitive region comprises selecting, from a set of sinographs, a sinograph made from a set of roots, each root being different from all other roots in said set.

10. The method of claim 1, further comprising:
displaying, to the challenged entity, a second region, said second region having an image of an unrecognized sinograph;
displaying, to the challenged entity, candidate sinographs corresponding to the unrecognized sinograph; and
soliciting, from said challenged entity, information identifying which of said candidate sinographs the challenged entity regards as the same as the unrecognized sinograph.

11. The method of claim 10, further comprising assessing a confidence in the challenged entity's identification of said candidate sinograph based at least in part on the success with which the challenged entity identified the real roots of said challenge sinograph.

12. The method of claim 10, wherein said unrecognized sinograph is a sinograph that OCR was unable to recognize.

13. An apparatus for soliciting input concerning a displayed sinograph, said apparatus comprising:
a challenge selector for selecting a sinograph for use as a challenge sinograph;
a rooter for obtaining at least one real root of said challenge sinograph and for obtaining at least one faux root;
a display module for causing a display to display an image of said challenge sinograph in a first display region, and images of said at least one faux root and said at least one real root in corresponding second and third display regions, said second and third display regions being event-sensitive regions.

14. The apparatus of claim 13, wherein the challenge selector is configured to select a sinograph on the basis of roots of said sinograph.

15. The apparatus of claim 13, wherein the rooter is configured to select said faux root on the basis of a resemblance between said faux root and a real root.

16. The apparatus of claim 13, wherein the rooter is configured to select said faux root such that said faux root and said real root have the same number of strokes.

17. A tangible and non-transitory computer readable medium having encoded thereon software for inviting a challenged entity to provide input concerning a sinograph, said software comprising instructions for executing the method recited in claim 1.

18. An apparatus for assessing an extent to which constituent elements of a sinograph are correctly identified, said apparatus comprising:
means for displaying, to a challenged entity, a sinograph, and constituent elements thereof, said constituent elements being displayed on event-sensitive regions;
means for receiving, from said challenged entity, information representative of interaction with said event-sensitive regions; and
means for assessing, based on said information, whether said challenged entity correctly identified said sinograph.

19. The apparatus of claim 18, further comprising means for displaying to said challenged entity, an unrecognized sinograph for which human assistance in recognition is sought.

20. The apparatus of claim 18, further comprising means for generating elements that mimic said constituent elements in appearance.
